(19) United States
(12) Patent Application Publication
(10) Pub. No.: US 2026/0061894 A1
(43) Pub. Date: Mar. 5, 2026

(54) LONG SLIDE RAIL SYSTEM FOR VEHICLE SEAT

(71) Applicant: HYUNDAI TRANSYS INC., Seosan-si (KR)

(72) Inventors: Cheon KIM, Hwaseong-si (KR); Seong Jun HWANG, Hwaseong-si (KR); Kyeong Ho SEO, Suwon-si (KR); Heoung Su LIM, Hwaseong-si (KR); Jae Yong JANG, Suwon-si (KR); Jung Hyun HAN, Hwaseong-si (KR)

(21) Appl. No.: 19/290,910

(22) Filed: Aug. 5, 2025

(30) Foreign Application Priority Data
Aug. 27, 2024 (KR) 10-2024-0115138

(51) Int. Cl. B60N 2/07; F16C 29/04

(52) U.S. Cl. CPC B60N 2/0732; F16C 29/04

(57) ABSTRACT

Disclosed is a long slide rail system for a vehicle seat, including a lower rail extending lengthwise along a vehicle floor panel, the lower rail being fixedly installed on the floor panel, an upper rail coupled to the lower rail, the upper rail being configured to enable a seat cushion to be slidably moved along the lower rail, a lock fork mounted on the upper rail, wherein the upper rail is slidably moved based on the lock fork being unlocked from a locking hole, a rotation bracket rotatably coupled by the lock fork, and a clearance control module formed to maintain vertical and horizontal clearances with respect to the lower rail, the clearance control module being configured to, based on the clearance control module being connected to the rotation bracket, selectively stop maintaining the vertical and horizontal clearances so as to enable sliding movement of the upper rail.

### CROSS-REFERENCE TO RELATED APPLICATION

This application claims priority, under 35 U.S.C. § 119 (a), to Korean Patent Application No. 10-2024-0115138, filed on Aug. 27, 2024, the entire contents of which are incorporated herein by reference.

### BACKGROUND

### (a) Technical Field

The present disclosure relates to a long slide rail system for a vehicle seat, and more particularly, to a long slide rail system for a vehicle seat, configured to prevent movement of the vehicle seat by restricting a vertical clearance and a horizontal clearance between a lower rail and an upper rail.

### (b) Background Art

In general, a vehicle seat includes a seatback and a seat cushion and is mounted on a seat sliding device configured to allow the seat cushion to be slidably moved in the forward-and-rearward direction of a vehicle body.

Normally, a front seat is mounted on a sliding device formed to have a short longitudinal length and configured to provide a short forward-and-rearward movement distance. Conversely, in the case of recreational vehicles (RVs) and vans having a larger vehicle body and a larger floor panel than those of passenger cars, a sliding device formed to have a long longitudinal length is installed therein to increase a degree of adjustment for a forward-and-rearward movement distance of a vehicle seat. Accordingly, sufficient leg room for a passenger may be secured, and a comfortable interior living space may be provided.

Typically, a long slide rail system is configured to provide a longer forward-and-rearward movement distance (approximately 400 to 1,000 mm) than a forward-and-rearward movement distance (approximately 200 to 300 mm) of a short slide rail system. Further, the long slide rail system is configured to include a lower rail embedded and mounted in a floor panel of a vehicle, and an upper rail connected to the lower rail so as to be movable along the lower rail in the forward-and-rearward direction and configured to be assembled with a vehicle seat.

In the long slide rail system, as the length of the lower rail increases, the dimensions of each section of the long slide rail system may not be constant. Accordingly, the following problems may occur due to a dimensional distribution.

First, since the upper rail is assembled with the lower rail where a dimensional distribution of each section is present, clearances present in some sections may be secured, but clearances present in other sections may not be reliably secured due to a dimensional distribution. In this case, vibration and shaking of the upper rail may occur when the upper rail slidably moves along the lower rail.

Second, since the dimensions of each section of the lower rail are not constant, a degree of coupling between the lower rail and a clearance-controlling member such as a roller or an injection-molded product may vary in each section, leading to a difference in operating force when the upper rail slidably moves along the lower rail.

Accordingly, customers may have an unsatisfactory operational feeling when operating a seat, and thus marketability of the seat may deteriorate. As a result, it is difficult to improve marketability and quality of the seat due to the above-described problems.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a long slide rail system for a vehicle seat, configured to maximally improve an operational feeling by maximally reducing friction with a lower rail in such a manner that an operating guide is inserted into a space formed between clutches when a lock fork is rotated to be unlocked from the lower rail, the clutches are moved in the leftward-and-rightward direction, a gap is selectively formed between a brake module and a housing, and a clearance-maintaining member connected to the brake module and configured to maintain a vertical clearance and a horizontal clearance with respect the lower rail becomes movable such that friction with the lower rail is not generated.

In one aspect, the present disclosure provides a long slide rail system for a vehicle seat, the long slide rail system including a lower rail extending lengthwise along a floor panel of a vehicle, the lower rail being fixedly installed on the floor panel, an upper rail coupled to the lower rail, the upper rail being configured to enable a seat cushion to be slidably moved along the lower rail, a lock fork mounted on the upper rail, wherein the upper rail is slidably movable based on the lock fork being unlocked from a locking hole formed on the lower rail, a rotation bracket rotatably coupled by the lock fork and configured to be rotated by the lock fork, and a clearance control module formed to maintain a vertical clearance and a horizontal clearance with respect to the lower rail, the clearance control module being configured to selectively stop maintaining the vertical clearance and the horizontal clearance with respect to the lower rail so as to enable sliding movement of the upper rail based on the clearance control module being connected to the rotation bracket.

In a preferred embodiment, a pair of the clearance control modules may be provided in forward-and-rearward directions relative to the lock fork.

In another preferred embodiment, the clearance control module may be selectively provided forwardly or rearwardly of the lock fork.

In still another preferred embodiment, the rotation bracket may include a main plate disposed to extend lengthwise so as to be selectively connected to the clearance control module, and a protruding member configured to guide and rotate the main plate in a direction allowing the main plate to be operatively connected to the clearance control module based on the lock fork being rotated to press the protruding member.

In yet another preferred embodiment, the rotation bracket may further include an elastic member configured to provide elasticity to the main plate so as to allow the main plate to be rotated in a direction allowing the main plate to be operatively disconnected from the clearance control module.

In still yet another preferred embodiment, the clearance control module may include a pair of clutches disposed to face each other such that the rotation bracket is inserted into a space between the clutches, the clutches configured to selectively move in leftward-and-rightward directions with respect to a main body of the clearance control module, housings each of which is mounted on a respective side of the main body of the clearance control module, the clutches located respectively inside the housings, and the housings including a plurality of roller members configured to support the clutches, movement guides configured to be pressed by the roller members, the movement guides configured to be selectively movable inside the respective housings based on movement of the roller members, and clearance-maintaining members connected to the respective movement guides, each of the clearance-maintaining members disposed to extend in a vertical direction and disposed to contact an upper surface and a side surface of the lower rail.

In a further preferred embodiment, the pair of clutches may include body portions each having a first side surface and a second side surface, the body portions arranged such that the respective first side surfaces of the body portions face and contact each other in the main body of the clearance control module, and a plurality of gap-generating portions formed to protrude from the second side surface of each of the body portions, the gap-generating portions disposed between the roller members.

In another further preferred embodiment, the body portions may include inclined surfaces formed on the respective first side surfaces of the body portions, the inclined surfaces having angles corresponding to each other.

In still another further preferred embodiment, the main body of the clearance control module may have a pair of elastic members mounted thereon, and the elastic members may be respectively connected to the body portions such that elastic forces from the elastic members bias the body portions toward one another.

In yet another further preferred embodiment, each of the gap-generating portions may be formed in a wedge shape having a width that gradually tapers from the body portions to a space between the roller members.

In still yet another further preferred embodiment, each of the housings may include a step portion formed along an edge thereof, the edge being located at a position corresponding to a position of the elastic member.

In a still further preferred embodiment, the movement guides may be configured to be movable inside the respective housings by a gap generated between the roller members, where the gap is generated by allowing each of the gap-generating portions to be inserted into a space between the roller members.

In a yet still further preferred embodiment, the clearance-maintaining members may be moved in conjunction with movement of the movement guides inside the respective housings so as to be disposed in a state in which friction between the clearance-maintaining members and upper and side surfaces of the lower rail is not generated.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity. The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are views each showing a long slide rail system for a vehicle seat according to an embodiment of the present disclosure;

FIG. 3 is a view showing a state in which a clearance is controlled by a clearance-maintaining member in the long slide rail system for a vehicle seat according to the embodiment of the present disclosure;

FIGS. 4A and 4B are views showing the separated state and the coupled state of a clearance control module with respect to the long slide rail system for a vehicle seat according to the embodiment of the present disclosure;

FIGS. 5 to 7 are views each showing the clearance control module when an upper rail is locked in the long slide rail system for a vehicle seat according to the embodiment of the present disclosure; and

FIGS. 8 to 10 are views each showing the clearance control module when locking of the upper rail is released in the long slide rail system for a vehicle seat according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, a preferred embodiment according to the present disclosure will be described in detail with reference to the accompanying drawings.

Advantages and features of the present disclosure and methods of achieving the same will become more apparent with reference to the embodiments described below in detail and the accompanying drawings.

However, the present disclosure is not limited by the embodiments disclosed below, and may be implemented in various forms. The embodiments are provided to make the present disclosure complete, and to fully inform those skilled in the art to which the present disclosure pertains of the scope of the disclosure, and the present disclosure is only defined by the scope of the claims.

In describing the embodiments disclosed herein, when it is determined that a detailed description of publicly known techniques to which the disclosure pertains may obscure the gist of the present disclosure, detailed description thereof will be omitted.

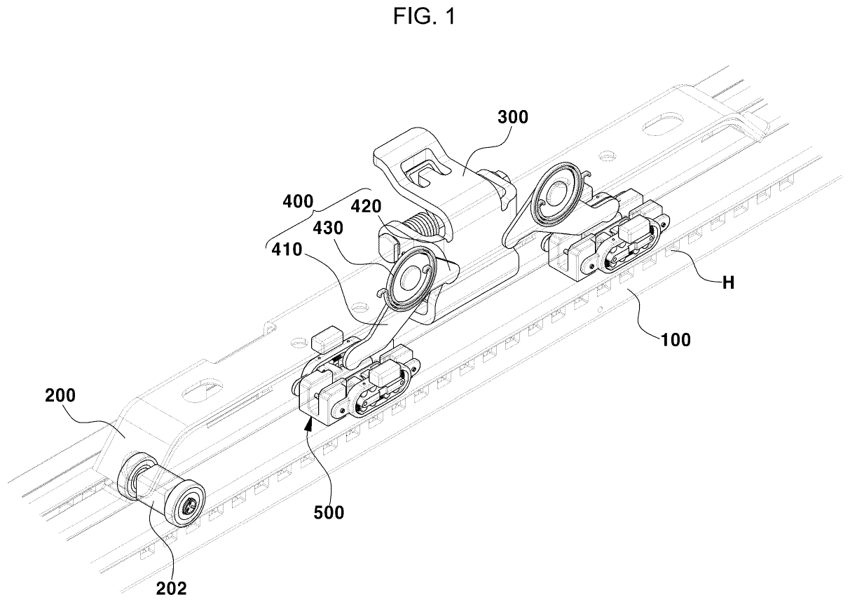

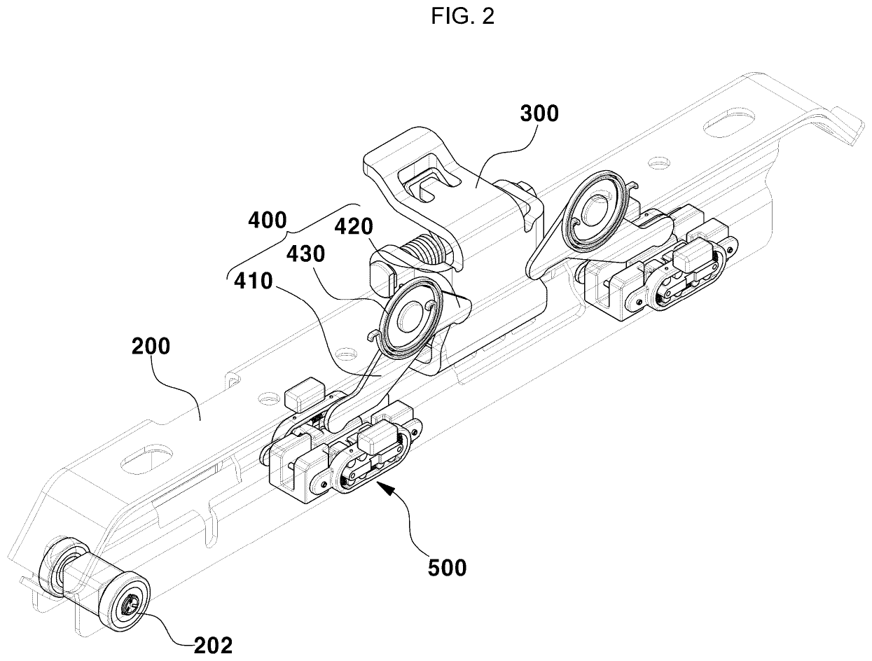

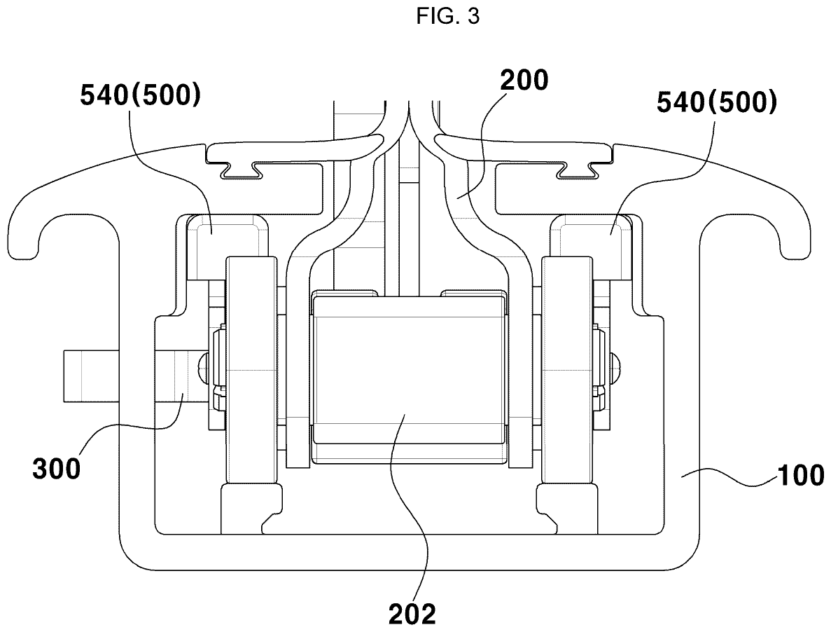

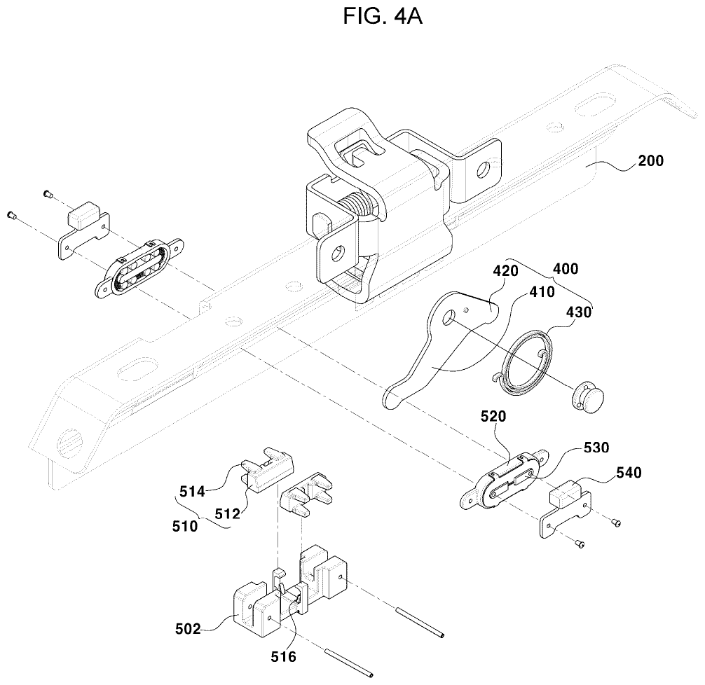

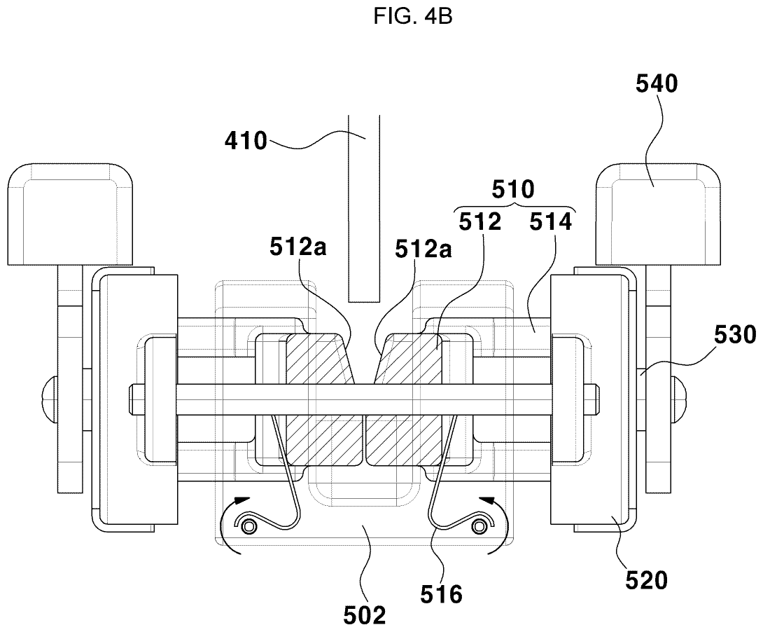

FIGS. 1 and 2 are views each showing a long slide rail system for a vehicle seat according to an embodiment of the present disclosure, FIG. 3 is a view showing a state in which a clearance is controlled by a clearance-maintaining member in the long slide rail system for a vehicle seat according to the embodiment of the present disclosure, and FIGS. 4A and 4B are views showing the separated state and the coupled state of a clearance control module with respect to the long slide rail system for a vehicle seat according to the embodiment of the present disclosure.

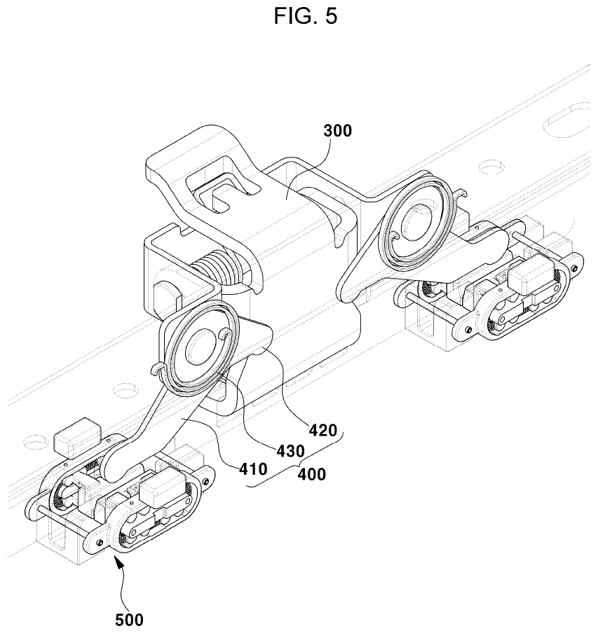

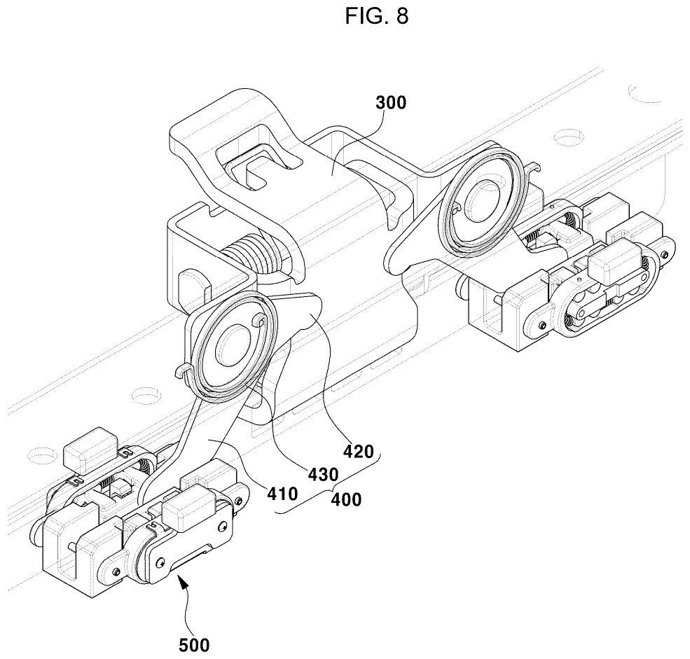

Additionally, FIGS. 5 to 7 are views each showing the clearance control module when an upper rail is locked in the long slide rail system for a vehicle seat according to the embodiment of the present disclosure, and FIGS. 8 to 10 are views each showing the clearance control module when locking of the upper rail is released in the long slide rail system for a vehicle seat according to the embodiment of the present disclosure.

As shown in FIGS. 1 and 2, the long slide rail system for a vehicle seat according to the present embodiment includes a lower rail 100, an upper rail 200, a lock fork 300, a rotation bracket 400, and a clearance control module 500.

The lower rail 100 extends lengthwise along a floor panel of a vehicle and is fixedly installed on the floor panel.

The upper rail 200 is coupled to the lower rail 100, and a seat cushion constituting a vehicle seat is coupled to the upper rail 200 so as to be slidably moved along the lower rail 100.

To this end, the upper rail 200 may include a plurality of rollers 202, and the upper rail 200 may be slidably moved in the forward-and-rearward direction of the lower rail 100 via the rollers 202.

The lock fork 300 is vertically rotatably mounted on the upper rail 200. When the lock fork 300 is rotated by a user so as to be unlocked from a locking hole H formed in the lower rail 100, the upper rail 200 may be slidably moved.

Accordingly, in a locking mode for the vehicle seat, the lock fork 300 is located to be locked in the locking hole H so as to restrict sliding movement of the upper rail 200, and in a moving mode for the vehicle seat, the lock fork 300 is unlocked from the locking hole H through axial rotation thereof on the upper rail 200 so as to enable sliding movement of the upper rail 200.

The rotation bracket 400 is coupled to the upper rail 200 and is rotatable by the lock fork 300.

That is, the rotation bracket 400 is configured to be rotated in conjunction with rotation of the lock fork 300 when the lock fork 300 is rotated to be unlocked from the locking hole H for execution of the moving mode for the vehicle seat.

The rotation bracket 400 may include a main plate 410 and a protruding member 420.

The main plate 410 is formed to extend so as to have a predetermined length, is located in a direction facing the clearance control module 500, and is rotatably axially coupled to the upper rail 200.

The main plates 410 may be rotatably axially coupled to the front side and the rear side of the upper rail 200, respectively, but the present disclosure is not limited thereto. The main plate 410 may be rotatably axially coupled to either the front side or the rear side of the upper rail 200.

The main plate 410 is provided to be axially rotated by the lock fork 300 when the lock fork 300 is rotated to be selectively unlocked from the locking hole H for execution of the moving mode.

To this end, the protruding member 420 is formed to protrude from the main plate 410 toward the lock fork 300. Here, when the lock fork 300 is rotated to press the protruding member 420, the main plate 410 may be guided to be rotated in a direction in which the main plate 410 is operatively connected to the clearance control module 500.

The rotation bracket 400 may further include an elastic member 430. When the main plate 410 is axially coupled to the upper rail 200, the elastic member 430 may provide elasticity to the main plate 410 so as to allow the main plate 410 to be rotated in a direction in which the main plate 410 is operatively disconnected from the clearance control module 500 facing the main plate 410. Here, the elastic member 430 allows the main plate 410 to be temporarily connected to the clearance control module 500 only when the lock fork 300 is unlocked from the locking hole H for execution of the moving mode.

As shown in FIG. 3, the clearance control module 500 includes a clearance-maintaining member 540 and is formed to maintain a vertical clearance and a horizontal clearance with respect to the lower rail 100. Further, when the clearance control module 500 is connected to the rotation bracket 400, the clearance-maintaining member 540 stops maintaining the vertical clearance and the horizontal clearance with respect to the lower rail 100 so as to enable smooth sliding movement of the upper rail 200.

The clearance control modules 500 may be respectively coupled to the front side and the rear side of the upper rail 200, but the present disclosure is not limited thereto. When the main plate 410 is rotatably coupled to either the front side or the rear side of the upper rail 200, the clearance control module 500 may be coupled to either the front side or the rear side of the upper rail 200 in a state of facing the main plate 410.

Here, the clearance control module 500 includes a clutch 510, a housing 520, a movement guide 530, and the clearance-maintaining member 540, as shown in FIGS. 4A and 4B.

A pair of clutches 510 is provided. Here, the clutches 510 are disposed to face each other so as to allow the rotation bracket 400 to be inserted into a space formed between the clutches 510. Further, the clutches 510 are formed to move in the leftward-and-rightward direction of the main body 502.

Each of the clutches 510 may include a body portion 512 and a gap-generating portion 514.

The body portions 512 may be formed such that a first side surface of one body portion 512 and a first side surface of another body portion 512 face each other and contact each other in the main body 502. Preferably, inclined surfaces 512a having angles corresponding to each other may be respectively formed on the first side surface of one body portion 512 and the first side surface of the other body portion 512.

Here, the main plate 410 is located above a pair of body portions 512 having the respective first side surfaces disposed to contact each other (refer to FIG. 4B). In this case, in order to connect the main plate 410 to the clearance control module 500, the rotation bracket 400 needs to be inserted into a space formed between the pair of body portions 512. To this end, the inclined surfaces 512a having angles corresponding to each other may be formed on the respective first side surfaces of the pair of body portions 512 facing each other, and the main plate 410 may be easily inserted into a space formed between the body portions 512 such that connection between the main plate 410 and the clearance control module 500 is enabled.

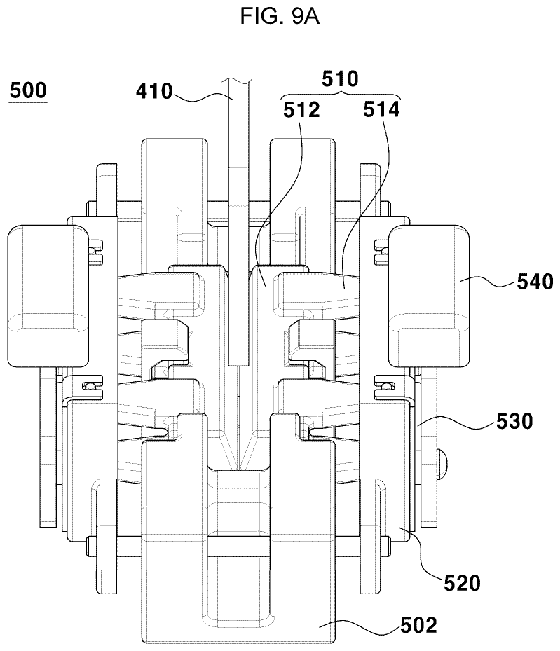

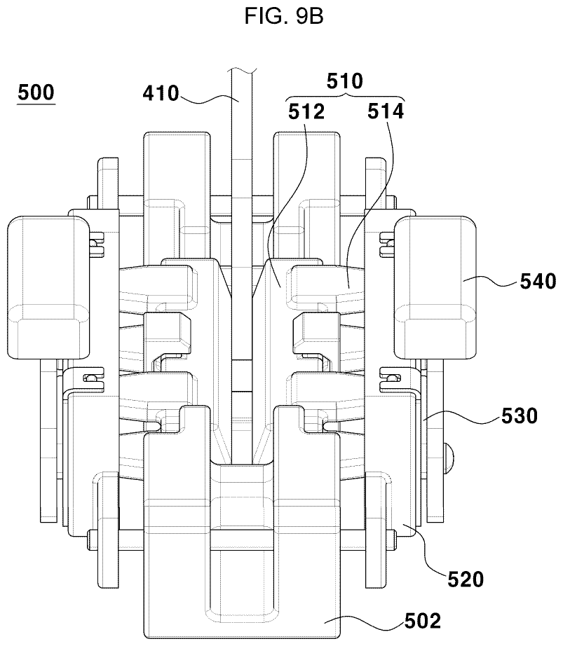

Here, the body portions 512 are respectively connected to a pair of elastic members 516 each made of a plate spring and mounted on the main body 502, and thus elastic forces generated from the respective elastic members are applied in directions facing each other so as to bias the body portions 512 toward one another (refer to FIG. 9A). Accordingly, it is possible to maintain a state in which the first side surface of one body portion 512 and the first side surface of another body portion 512 are located to contact each other. Here, when the operation mode switches from the locking mode to the moving mode such that the rotation bracket 400 is inserted into a space formed between the body portions 512, horizontal movement may be selectively performed (refer to FIG. 9B).

In addition, the gap-generating portion 514 is formed in plural on the second side surface of each of the body portions 512. Each of the gap-generating portions 514 is formed to protrude and is located between roller members 522 provided in the housing 520.

Preferably, each of the gap-generating portions 514 may be formed to have a wedge shape, the width of which gradually tapers from the body portions 512 to a space between the roller members 522. As described above, when the pair of body portions 512 is moved in the leftward-and-rightward direction, the gap-generating portions 514 are inserted into the housing 520 such that the plurality of roller members 522 is moved forwards and rearwards according to the increased widthwise length of the gap-generating portions 514. In this manner, a gap between the roller members 522 is increased.

In addition, each of the housings 520 is mounted on a respective side of the main body 502, and the clutch 510, more specifically, the gap-generating portion 514, is located inside the housing 520. Further, the housing 520 has a plurality of roller members 522 provided therein and configured to support the gap-generating portion 514 and the movement guide 530.

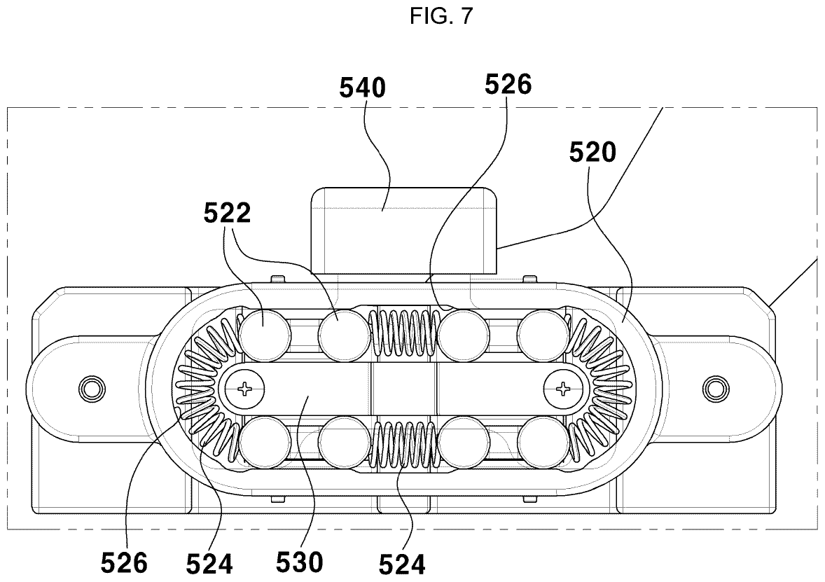

In addition, the housing 520 has elastic members 524 located in spaces excluding spaces filled by the roller members 522 and provided for insertion of the gap-generating portion 514 and configured to connect a plurality of roller members 522 to each other by the elastic members 524. Through such a structural configuration, it is possible to prevent the occurrence of a gap between the inner edge of the housing 520, the roller members 522, and the movement guide 530. In this manner, the movement guide 530 may be maintained in a fixed state inside the housing 520 (refer to FIG. 7).

In addition, the housing 520 may include a step portion 526. Preferably, the step portion 526 may be formed along the inner edge of the housing 520 at a plurality of locations corresponding to the locations of the elastic members 524.

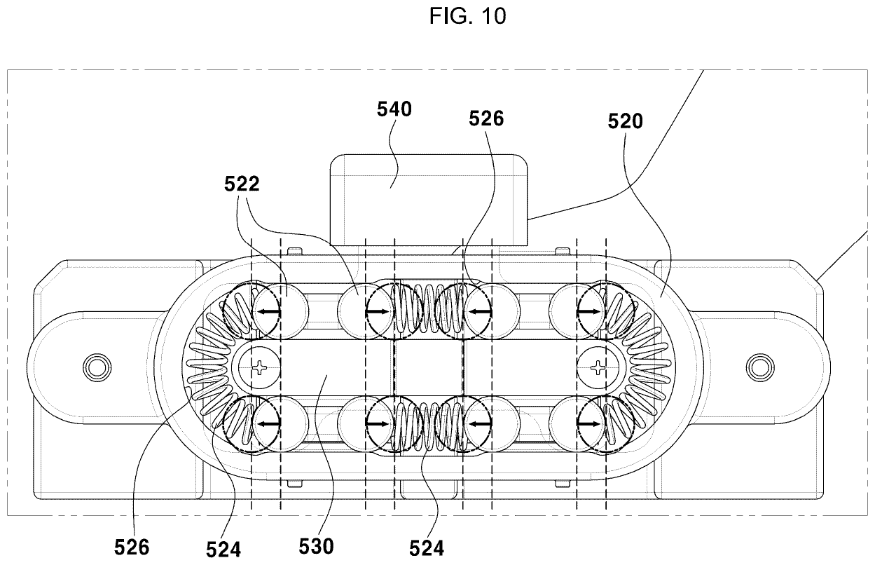

The step portion 526 corresponds to an area in which the roller member 522 is located by forward-and-rearward movement thereof due to insertion of the gap-generating portion 514. Here, since the step portion 526 is formed to have a smaller thickness than that of the inner edge of the housing 520, a gap may be generated between the roller member 522 and the movement guide 530, thereby enabling the movement guide 530 to be freely moved inside the housing 520 (refer to FIG. 10).

The movement guide 530 may be pressed by the roller member 522 inside the housing 520 and may be selectively additionally moved in a state in which the gap-generating portion 514 is inserted into a space formed between the roller members 522. Then, when the roller member 522 is moved toward the step portion 526, the movement guide 530 becomes movable inside the housing 520.

The clearance-maintaining member 540 is connected to the rear surface of the movement guide 530 and is disposed to extend in the vertical direction so as to contact the upper surface and the side surface of the lower rail 100 (refer to FIG. 3).

The clearance-maintaining member 540 may be made of a material such as elastic rubber and may be disposed to contact the lower rail 100 so as to maintain a vertical clearance and a horizontal clearance in the locking mode.

In addition, when the operation mode switches from the locking mode to the moving mode according to the operation of the lock fork 300, the clearance-maintaining member 540 stops maintaining the vertical clearance and the horizontal clearance with respect to the lower rail 100 so as to enable smooth sliding movement of the upper rail 200. In this manner, an operational feeling may be maximally improved by maximally reducing frictional force with the lower rail 100.

Hereinafter, a description will be given as to the operating state of the clearance control module 500 when the operation mode switches from the locking mode to the moving mode based on the above-described configuration.

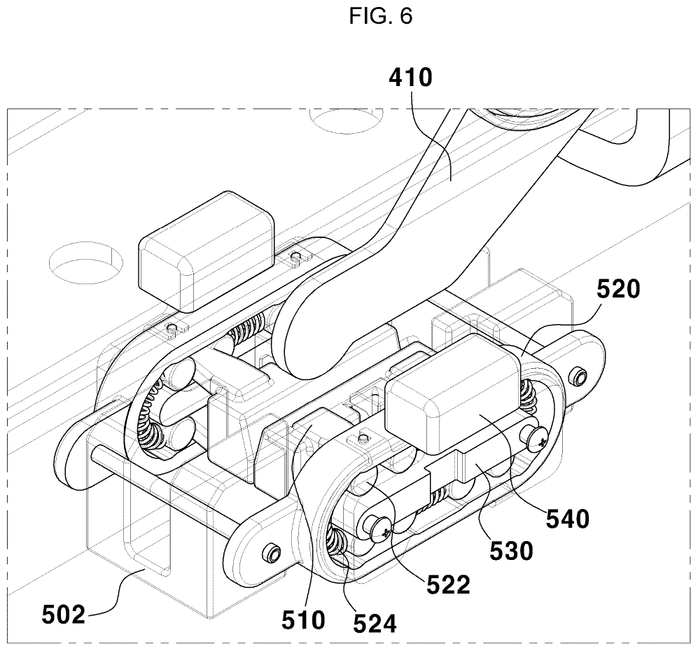

As shown in FIGS. 5 and 6, in the locking mode, since the lock fork 300 is located to be locked in the locking hole H, the main plate 410 is fixed in a state of being disconnected from the clearance control module 500 by elastic force applied thereto from the elastic member 430.

In this state, as shown in FIG. 7, since a gap between the inner edge of the housing 520, the roller member 522, and the movement guide 530 is not structurally generated, the movement guide 530 is maintained in a fixed state inside the housing 520. Accordingly, the clearance-maintaining member 540 is also maintained in a fixed state of maintaining a vertical clearance and a horizontal clearance with respect to the lower rail 100.

As shown in FIG. 8, when the lock fork 300 is rotated in a direction in which the lock fork 300 is unlocked from the locking hole H in order to switch the operation mode from the locking mode to the moving mode, the protruding member 420 is rotated by the lock fork 300, and the main plate 410 is also rotated in a direction in which the main plate 410 is inserted into a space between the clutches 510.

In this manner, when the main plate 410 is inserted into a space between the clutches 510, more specifically, a space between a pair of body portions 512, as shown in FIGS. 9A and 9B, the body portion 512 is moved in the leftward-and-rightward direction, and then the gap-generating portion 514 is inserted into the housing 520.

Here, as shown in FIG. 10, when the gap-generating portion 514 is inserted thereinto, a plurality of roller members 522 is moved in the forward-and-rearward direction and is located at the position of the step portion 526. At this time, since the step portion 526 is formed to have a smaller thickness than that of the inner edge of the housing 520, a gap is generated between the roller member 522 and the movement guide 530.

Through such a structural configuration, the movement guide 530 is freely movable inside the housing 520. Accordingly, the clearance-maintaining member 540 coupled to the movement guide 530 is also freely movable, and thus a vertical clearance and a horizontal clearance with respect to the lower rail 100 may not be maintained. As a result, the upper rail 200 may be easily slidably moved along the lower rail 100, and an operational feeling may be maximally improved by maximally reducing friction with the lower rail 100.

According to the present disclosure, when a lock fork is rotated to be unlocked from a lower rail, an operating guide is inserted into a space formed between clutches, the clutches are moved in the leftward-and-rightward direction, and a gap is selectively formed between a brake module and a housing. In this case, a clearance-maintaining member connected to the brake module and configured to maintain a vertical clearance and a horizontal clearance with respect the lower rail becomes movable such that friction with the lower rail is not generated. As a result, it is possible to achieve an effect of maximally improving an operational feeling by maximally reducing friction with the lower rail.

Furthermore, according to the present disclosure, when an upper rail is locked, the gap between the brake module and the housing is not generated by a plurality of roller members, and the clearance-maintaining member is fixedly maintained according to fixation of the brake module. In this manner, it is possible to effectively maintain a vertical clearance and a horizontal clearance of the upper rail through one clearance-maintaining member, thereby having an effect of preventing vertical movement and horizontal movement of a seat in a fixed state.

As is apparent from the above description, the present disclosure provides a long slide rail system for a vehicle seat, configured to maximally improve an operational feeling by maximally reducing friction with a lower rail in such a manner that an operating guide is inserted into a space formed between clutches when a lock fork is rotated to be unlocked from the lower rail, the clutches are moved in the leftward-and-rightward direction, a gap is selectively formed between a brake module and a housing, and a clearance-maintaining member connected to the brake module and configured to maintain a vertical clearance and a horizontal clearance with respect the lower rail becomes movable such that friction with the lower rail is not generated.

Furthermore, in the long slide rail system of the present disclosure, when an upper rail is locked, the gap between the brake module and the housing is not generated by a plurality of roller members, and the clearance-maintaining member is fixedly maintained according to fixation of the brake module. In this manner, it is possible to effectively maintain a vertical clearance and a horizontal clearance of the upper rail through one clearance-maintaining member, thereby having an effect of preventing vertical movement and horizontal movement of a seat in a fixed state.

The present disclosure has been described in detail with reference to preferred embodiments shown in the drawings, but the embodiments are merely illustrative. It will be appreciated by those skilled in the art that various modifications may be made from the embodiments, and all or a part of the embodiments may be selectively combined with each other. Therefore, the true technical protection scope of the present disclosure should be defined by the technical spirit of the appended claims.

What is claimed is:

1. A long slide rail system for a vehicle seat, the long slide rail system comprising:
a lower rail configured to extend lengthwise along a floor panel of a vehicle, the lower rail configured to be fixedly installed on the floor panel;
an upper rail coupled to the lower rail, the upper rail configured to enable a seat cushion to be slidably moved along the lower rail;
a lock fork mounted on the upper rail, the upper rail being slidably movable based on the lock fork being unlocked from a locking hole formed on the lower rail;
a rotation bracket coupled to the upper rail and configured to be rotated by the lock fork; and
a clearance control module configured to maintain a vertical clearance and a horizontal clearance with respect to the lower rail, the clearance control module configured to selectively stop maintaining the vertical clearance and the horizontal clearance with respect to the lower rail so as to enable sliding movement of the upper rail based on the clearance control module being connected to the rotation bracket.

2. The long slide rail system of claim 1, wherein a pair of the clearance control modules is provided in forward-and-rearward directions relative to the lock fork.

3. The long slide rail system of claim 1, wherein the clearance control module is selectively provided either forwardly or rearwardly of the lock fork.

4. The long slide rail system of claim 1, wherein the rotation bracket comprises:
a main plate disposed to extend lengthwise so as to be selectively connected to the clearance control module; and
a protruding member configured to guide and rotate the main plate in a direction allowing the main plate to be operatively connected to the clearance control module based on the lock fork being rotated to press the protruding member.

5. The long slide rail system of claim 4, wherein the rotation bracket further comprises an elastic member configured to provide elasticity to the main plate such that the main plate is rotated in a direction allowing the main body to be operatively disconnected from the clearance control module.

6. The long slide rail system of claim 1, wherein the clearance control module comprises:
a pair of clutches disposed to face each other such that the rotation bracket is inserted into a space between the clutches, the clutches configured to selectively move in leftward-and-rightward directions with respect to a main body of the clearance control module;
housings each of which is mounted on a respective side of the main body of the clearance control module, the clutches configured to be located respectively inside the housings, the housings including a plurality of roller members configured to support the clutches;
movement guides configured to be pressed by the roller members, the movement guides configured to be selectively movable inside the respective housings based on movement of the roller members; and
clearance-maintaining members connected to the respective movement guides, each of the clearance-maintaining members disposed to extend in a vertical direction and disposed to contact an upper surface and a side surface of the lower rail.

7. The long slide rail system of claim 6, wherein the pair of clutches comprises:
body portions each having a first side surface and a second side surface, the body portions arranged such that the respective first side surfaces of the body portions face and contact each other in the main body of the clearance control module; and
a plurality of gap-generating portions formed to protrude from the second side surface of each of the body portions, the gap-generating portions disposed between the roller members.

8. The long slide rail system of claim 7, wherein the body portions comprise inclined surfaces formed on the first side surfaces of the body portions, the inclined surfaces having angles corresponding to each other.

9. The long slide rail system of claim 7, wherein the main body of the clearance control module has a pair of elastic members mounted thereon, and the elastic members are respectively connected to the body portions such that elastic forces from the elastic members bias the body portions toward one another.

10. The long slide rail system of claim 7, wherein each of the gap-generating portions is formed in a wedge shape having a width that gradually tapers from the body portions to a space between the roller members.

11. The long slide rail system of claim 7, wherein each of the housings includes an elastic member located in spaces excluding spaces filled by the roller members and provided for insertion of the gap-generating portions, the elastic members configured to connect the roller members to each other.

12. The long slide rail system of claim 11, wherein each of the housings includes a step portion formed along an edge thereof, the edge being located at a position corresponding to a position of the elastic member.

13. The long slide rail system of claim 12, wherein the movement guides are configured to be movable inside the respective housings by a gap generated between the roller members, the gap being generated by allowing each of the gap-generating portions to be inserted into a space between the roller members.

14. The long slide rail system of claim 13, wherein the clearance-maintaining members are configured to be moved in conjunction with movement of the movement guides inside the respective housings so as to be disposed in a state in which friction between the clearance-maintaining members and upper and side surfaces of the lower rail is not generated.
